(19) United States
(12) Patent Application Publication
(10) Pub. No.: US 2009/0148818 A1
(43) Pub. Date: Jun. 11, 2009

(54) Personalized meal planning mehtod and system thereof

(75) Inventors: Huan-Chung LI, Toufen Township (TW); Wei-Min Ko, Kaohsiung City (TW); Shun-Chi Chung, Jhonghe City (TW)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: INSTITUE FOR INFORMATION INDUSTRY

(21) Appl. No.: 12/009,695

(22) Filed: Jan. 22, 2008

(30) Foreign Application Priority Data
Dec. 11, 2007 (TW) 96147268

(51) Int. Cl. G09B 19/00

(52) U.S. Cl. 434/127

(57) ABSTRACT

A personalized meal planning method is provided. The method utilizes a food clustering technique to generate personalized meal plans. The method provides a food clustering stage and a food matching stage. The food clustering stage includes the following steps: input a personal nutrient goal; set a weight and a necessity value for each target nutrient feature; generate food clusters by applying a clustering algorithm; compute food ranking; and provide a diet recommendation. The food matching stage includes the following steps: select a food item to be replaced; determine a threshold of target similarity; and provide at least one replaceable food item. A personalized meal planning system is also provided.

### RELATED APPLICATIONS

This application claims priority to Taiwan Application Serial Number 96147268, filed Dec. 11, 2007, which is herein incorporated by reference.

### BACKGROUND

1. Field of Invention

The present invention relates to a method and system of personalized meal planning. More particularly, the present invention relates to a method and system of personalized meal planning utilizing a food clustering technique.

2. Description of Related Art

People are being made aware of the importance of leading a healthy life style. One aspect of leading a healthy life style is eating balanced nutritious foods. For healthy people, well-balanced meals are helpful in preventing diseases. For patients with chronic diseases such as diabetes, eating appropriate foods is helpful to manage existing diseases and slowing the development rate of diseases. Thus, personalized meal planning methods are already available to provide meal planning services.

However, these methods may not provide the best results since they do not accurately take into account various food characteristics, diet care requirements, and the relationships between different types of foods. These methods do not provide replaceable food items in case there is need of food substitution for patients.

For the foregoing reasons, there is a need to provide improvement with a personalized meal planning method and system thereof.

### SUMMARY

An objective of the present invention is to provide a method of personalized meal planning.

Another objective of the present invention is to provide a system of personalized meal planning.

To achieve the foregoing objectives, and in accordance with the purpose of the present invention as broadly described herein, the present invention considers personal nutrient goals and personal preferences, generates food clusters utilizing a food clustering technique, computes food ranking, and provides diet recommendations. Thus, the present invention will be helpful in creating new food groups and replaceable food items that are hierarchically ranked.

The method of personalized meal planning provides a food clustering stage and a food matching stage. The food clustering stage includes the following steps: input a personal nutrient goal; set a weight and a necessity value for each target nutrient feature; generate food clusters by applying a clustering algorithm; compute food ranking; and provide a diet recommendation. The food matching stage includes the following steps: select a food item to be replaced; determine a threshold of target similarity; and provide at least one replaceable food item.

The system of personalized meal planning includes a food database, a data collecting module, a nutrient feature weighting module, a food clustering module, a food ranking module, a food cluster database, a diet recommendation module, and a food matching module. The food database provides food items and nutrient features thereof. The data collecting module collects a personal nutrient goal from a user. The nutrient feature weighting module allows the user to set the weight and the necessity value for each target nutrient feature. The food clustering module generates food clusters by applying a clustering algorithm. The food ranking module computes food ranking among the food items in the food clusters. The food cluster database stores the data related to the food clusters. The diet recommendation module provides a diet recommendation. The food matching module provides replaceable food matching based upon a threshold of target similarity.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing the steps of providing food clustering according to one preferred embodiment of this invention;

FIG. 2 is a flow chart showing the steps of providing food matching according to one preferred embodiment of this invention;

FIG. 3 is a diagram illustrating the food clusters created at the food clustering stage according to one preferred embodiment of this invention;

FIG. 4 is a diagram illustrating the food items and ranks in a food cluster at the step of providing a diet recommendation according to one preferred embodiment of this invention;

FIG. 5 is a diagram illustrating the system of personalized meal planning according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

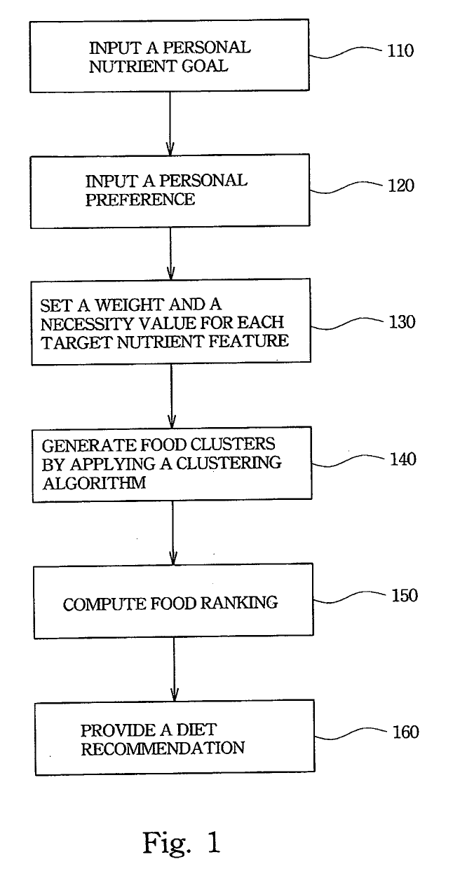

The user of the method and the system of personalized meal planning can be an average person or an expert from the health care industry such as a nutritionist and a doctor. The method of personalized meal planning provides a food clustering stage and a food matching stage. Reference is now made to FIG. 1, which is a flow chart showing the steps of providing food clustering according to one preferred embodiment of this invention. At the food clustering stage, a user inputs a personal nutrient goal first (step 110). The personal nutrient goal includes a target nutrient feature based on personal health conditions. The user selects nutrient features that need to be absorbed or avoided under different health conditions. For instance, when the user needs to reduce the absorption amount of calorie, protein, fat, carbohydrate, and cholesterol, then calorie, protein, fat, carbohydrate, and cholesterol would be selected as the target nutrient features in step 110. The user can also input a personal preference (step 120). The user inputs food categories based on personal preferences. The user can refine search results by entering or selecting search criteria such as typing in keywords like “meat” or selecting one food group from the 6 major food categories or the 18 major food categories. After that, set a weight and a necessity value for each target nutrient feature (step 130) based on the importance level of the target nutrient features to certain diseases or health conditions. The necessity value of a target nutrient feature can be set as high or low. In the provided example, the weight of calorie is set to 1, the weight of protein is set to 0.5, the weight of fat is set to 0.5, the weight of carbohydrate is set to 1, and the weight of cholesterol is set to 0.3. The necessity value of calorie, protein, fat, carbohydrate, and cholesterol are all set to low. Then, food items satisfying the criteria of the target nutrient feature and the personal preference will be collected from a food database and displayed.

The following three tables illustrate the process of weighting and normalizing the data of the collected food items. Table 1 shows the raw data of the food items collected from the food database according to the target nutrient feature. The nutrient feature of the food items is calculated using 100 g as unit of measure. The data is weighted accordingly with regards to the 5 target nutrient features. The weighted result is shown in Table 2. The normalized data is shown in Table 3 and ranged from 0 to 1.

TABLE 1

| food item | | | | | |
|---|---|---|---|---|---|
| name | calorie | protein | fat | carbohydrate | cholesterol |
| round of beef | 117 | 16.3 | 5.2 | 5 | 60 |
| ham | 96 | 18.9 | 2.3 | 0 | 47 |
| rice cake | 201 | 8.2 | 1.1 | 40 | 21 |
| pork jerky | 328 | 28.8 | 4.5 | 43.4 | 130 |
| duck | 111 | 20.9 | 2.4 | 0 | 93 |
| chicken thigh | 141 | 18.4 | 6.9 | 0.2 | 80 |
| goose | 187 | 15.6 | 13.4 | 2.4 | 71 |
| snake | 85 | 19 | 0.4 | 0 | 90 |
| fish jerky | 467 | 28.2 | 20.2 | 43.8 | 100 |

TABLE 2

| food item | | | | | |
|---|---|---|---|---|---|
| name | calorie | protein | fat | carbohydrate | cholesterol |
| round of beef | 117 | 8.15 | 2.6 | 5 | 18 |
| ham | 96 | 9.45 | 1.15 | 0 | 14.1 |
| rice cake | 201 | 4.1 | 0.55 | 40 | 6.3 |
| pork jerky | 328 | 14.4 | 2.25 | 43.4 | 39 |
| duck | 111 | 10.45 | 1.2 | 0 | 27.9 |
| chicken thigh | 141 | 9.2 | 3.45 | 0.2 | 24 |
| goose | 187 | 7.8 | 6.7 | 2.4 | 21.3 |
| snake | 85 | 9.5 | 0.2 | 0 | 27 |
| fish jerky | 467 | 14.1 | 10.1 | 43.8 | 30 |

TABLE 3

| food item | | | | | |
|---|---|---|---|---|---|
| name | calorie | protein | fat | carbohydrate | cholesterol |
| round of beef | 0.25 | 0.44 | 0.26 | 0.11 | 0.46 |
| ham | 0.21 | 0.51 | 0.11 | 0 | 0.36 |
| rice cake | 0.43 | 0.22 | 0.05 | 0.91 | 0.16 |
| pork jerky | 0.7 | 0.78 | 0.22 | 0.99 | 1 |
| duck | 0.24 | 0.57 | 0.12 | 0 | 0.71 |
| chicken thigh | 0.3 | 1 | 0.34 | 0 | 0.61 |
| goose | 0.4 | 0.42 | 0.66 | 0.05 | 0.54 |
| snake | 0.18 | 0.52 | 0.02 | 0 | 0.69 |
| fish jerky | 1 | 0.77 | 1 | 1 | 0.76 |

Next, generate food clusters by applying a clustering algorithm (step 140). Clustering is the process of organizing objects into groups whose members are similar in some way. A cluster is therefore a collection of objects which are similar to each other but dissimilar to the objects belonging to other clusters. Clustering can process large-sized databases efficiently. Here, the clustering algorithm is a Hierarchical Agglomerative Algorithm. This algorithm starts by placing each object in its own cluster and then merges the atomic clusters into larger and larger clusters, until all of the objects are in a single cluster or until certain termination conditions are satisfied. Algorithms that are representative of the Hierarchical Agglomerative Algorithm include Single-Linkage or Nearest Neighbor, Complete-Linkage or Furthest Neighbor, and Average-Linkage. These algorithms differ in the way they compute the distance between a pair of clusters. The distance measurement between a pair of clusters is in turn regarded as the similarity measurement between a pair of clusters. In this embodiment, Average-Linkage Agglomerative Algorithm is used to generate clusters, and Euclidean distance is used to compute the distance between two objects.

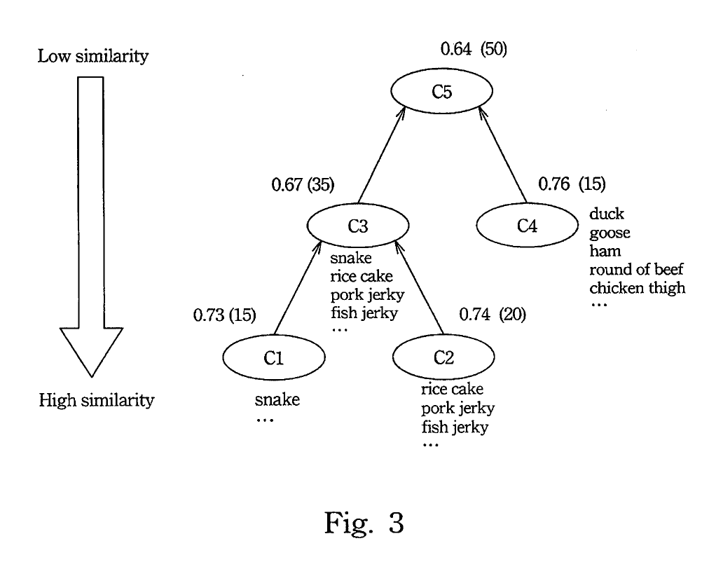

Reference in now made to FIG. 3, which is a diagram illustrating the food clusters created at the food clustering stage according to one preferred embodiment of this invention. Food cluster C1, C2, C3, C4, and C5 are generated after Average-Linkage Agglomerative Algorithm is applied. The similarity of food cluster C3 is 0.67, and there are 35 food items in the food cluster C3. The food items include snake, rice cake, pork jerky, fish jerky and so forth. Food clusters near the bottom have higher similarities and fewer food items, while food clusters near the top has lower similarities and more food items.

At step 140, the user can also define a threshold of similarity among the food items in the food clusters to control the convergence level of each of the food clusters. When a food cluster has a higher similarity value, the convergence level of the food cluster increases, but the number of food items decreases. The user can also define the number of food items in the food clusters to control the size of each of the food clusters.

After food clusters are generated, compute food ranking for food items in food clusters (step 150). First, calculate a ranking value for each food item f with the equation: ranking(f)=ΣWiNi. In the equation, Wi is the weight of target nutrient feature i of food item f. Ni is the value of target nutrient feature i of food item f. Ni is positive when the necessity value of target nutrient feature of food item f is set to high, and Ni is negative when the necessity value of target nutrient feature i of food item f is set to low. Then, rank the food items based on these calculated ranking values.

In this embodiment, the target nutrient features are calorie, protein, fat, carbohydrate, and cholesterol, and the necessity values of these target nutrient features are set as low. So, the values of Ni are all negative. The computing results of the ranking values are shown in Table 4.

TABLE 4

| food item name | calorie | protein | fat | carbohydrate | cholesterol | ranking(f) | rank |
|---|---|---|---|---|---|---|---|
| ham | 0.21 | 0.51 | 0.11 | 0 | 0.36 | −1.19 | 1 |
| round of beef | 0.25 | 0.44 | 0.26 | 0.11 | 0.46 | −1.52 | 2 |
| duck | 0.24 | 0.57 | 0.12 | 0 | 0.71 | −1.64 | 3 |
| goose | 0.4 | 0.42 | 0.66 | 0.05 | 0.54 | −2.07 | 4 |
| chicken thigh | 0.3 | 1 | 0.34 | 0 | 0.61 | −2.25 | 5 |

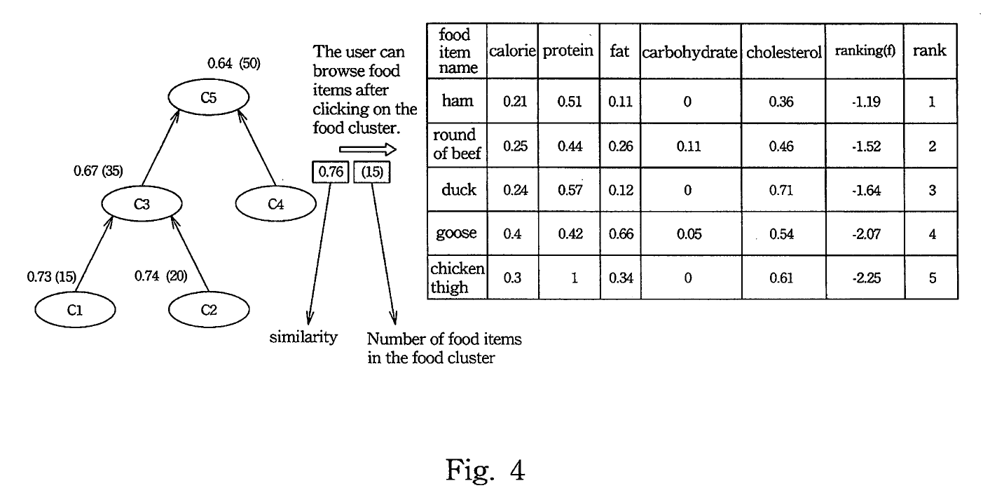

The last step at the food clustering stage is to provide a diet recommendation (step 160) based on the ranking result. This embodiment provides hierarchical food clusters with a visual presentation. As FIG. 4 shows, the user clicks on one of the food clusters and browses over the food items and ranks within. The user is able to browse the diet recommendation by category as well. For instance, the user types in a food category “fish”, and food items in the food cluster that are fish-related are displayed accordingly.

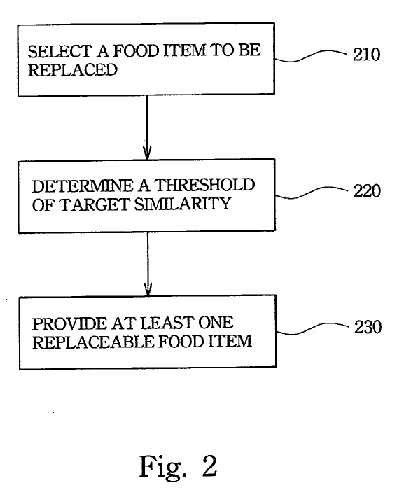

Reference is now made to FIG. 2, which is a flow chart showing the steps of providing food matching according to one preferred embodiment of this invention. In the food matching stage, select a food item to be replaced (step 210); determine a threshold of target similarity (step 220); and provide at least one replaceable food item (step 230). After the user selects a food item to be replaced, if the threshold of target similarity is determined as equal to the similarity of the food cluster to which the food item to be replaced belongs, the method provides the food ranking result of the food cluster to which the food item to be replaced belongs. This happens when the user simply looks for a replaceable food item within the same food cluster. On the other hand, when the threshold of target similarity is determined as not equal to the similarity of the food cluster to which the food item to be replaced belongs, the method generates the corresponding food clusters, computes food ranking, and provides at least one replaceable food item. This happens when the user looks for a replaceable food item in other food clusters with higher or lower similarities.

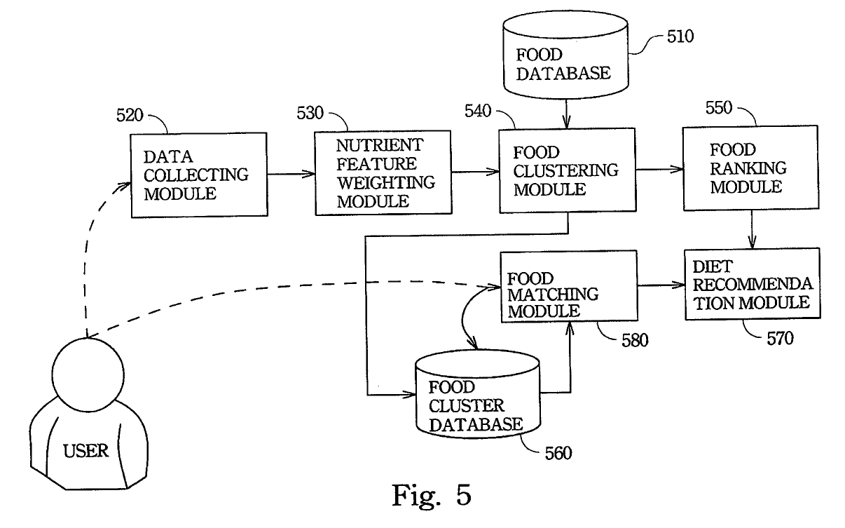

Reference is now made to FIG. 5, which is a diagram illustrating the system of personalized meal planning according to one preferred embodiment of this invention. The system of personalized meal planning includes a food database 510, a data collecting module 520, a nutrient feature weighting module 530, a food clustering module 540, a food ranking module 550, a food cluster database 560, a diet recommendation module 570, and a food matching module 580.

The food database 510 provides food items and nutrient features thereof. The data collecting module 520 collects a personal nutrient goal from a user. The nutrient feature weighting module 530 allows the user to set a weight and a necessity value for each target nutrient feature. The food clustering module 540 generates food clusters by applying a clustering algorithm. The food ranking module 550 computes food ranking among the food items in the food clusters. The food cluster database 560 stores the data related to the food clusters. The diet recommendation module 570 provides a diet recommendation. The food matching module 580 provides replaceable food matching based upon a threshold of target similarity.

The food database 510 stores a great deal of common food items and nutrient features thereof. The data collecting module 520 collects a personal nutrient goal from a user. The personal nutrient goal includes a target nutrient feature based on personal health conditions. The user selects nutrient features that need to be absorbed or avoided under different health conditions. In addition, the data collecting module 520 can collect a personal preference from the user. The user inputs food categories based on personal preferences. The user can refine search results by entering or selecting search criteria such as typing in keywords like “meat” or selecting one food group from the 6 major food categories or the 18 major food categories. The nutrient feature weighting module 530 allows the user to set a weight and a necessity value for each target nutrient feature based on the importance level of the target nutrient features to certain diseases or health conditions. The necessity value of a target nutrient feature can be set as high or low.

The food clustering module 540 searches the food database 510 for food items satisfying the criteria of the target nutrient feature and the personal preference, and then generates food clusters by applying a clustering algorithm. Here, the clustering algorithm is a Hierarchical Agglomerative Algorithm. Algorithms that are representative of the Hierarchical Agglomerative Algorithm include Single-Linkage or Nearest Neighbor, Complete-Linkage or Furthest Neighbor, and Average-Linkage. These algorithms differ in the way they compute the distance between a pair of clusters. The distance measurement between a pair of clusters is in turn regarded as the similarity measurement between a pair of clusters. In this embodiment, Average-Linkage Agglomerative Algorithm is used to generate clusters, and Euclidean distance is used to compute the distance between two objects. The outcome of food clustering is stored in the food cluster database 560. The food clustering module 540 can control the convergence level of each of the food clusters based on a threshold of similarity. When a food cluster has a higher similarity value, the convergence level of the food cluster increases, but the number of food items decreases. Besides, The food clustering module 540 can control the size of each of the food clusters based on the number of food items in the food clusters designated by the user.

The food ranking module 550 computes food ranking among the food items in the food clusters. First, the food ranking module 550 calculates a ranking value for each food item f with the equation: ranking(f)=ΣWiNi. In the equation, Wi is the weight of target nutrient feature i of food item f. Ni is the value of target nutrient feature i of food item f. Ni is positive when the necessity value of target nutrient feature i of food item f is set to high, and Ni is negative when the necessity value of target nutrient feature i of food item f is set to low. Then, the food ranking module 550 ranks the food items based on these calculated ranking values.

The food matching module 580 obtains data of food clusters from the food cluster database 560, and provides at least one replaceable food item based upon a threshold of target similarity. If the food matching module 580 determines the threshold of target similarity as equal to the similarity of the food cluster to which the food item to be replaced belongs, the food matching module 580 provides the food ranking result of the food cluster to which the food item to be replaced belongs. This happens when the user simply looks for a replaceable food item within the same food cluster. On the other hand, If the food matching module 580 determines the threshold of target similarity as not equal to the similarity of the food cluster to which the food item to be replaced belongs, the food clustering module 540 generates the corresponding food clusters, the food ranking module 550 computes food ranking, and the food matching module 580 provides at least one replaceable food item. This happens when the user looks for a replaceable food item in other food clusters with higher or lower similarities.

The diet recommendation module 570 provides a diet recommendation to the user. This embodiment provides hierarchical food clusters with a visual presentation. The diet recommendation module 570 allows the user to click on one of the food clusters and browse over the food items and ranks within. The diet recommendation module 570 allows the user to browse the diet recommendation by category as well.

As embodied and broadly described herein, the embodiment considers personal nutrient goals and personal preferences, generates food clusters utilizing a food clustering technique, computes food ranking, and provides diet recommendations. Thus, the present invention will be helpful in creating new food groups and replaceable food items that are hierarchically ranked.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of personalized meal planning, utilizing a food clustering technique to generate personalized meal plans, comprising:
providing a food clustering stage, the food clustering stage comprising:
(a) inputting a personal nutrient goal;
(b) setting a weight and a necessity value for each target nutrient feature;
(c) generating a plurality of food clusters by applying a clustering algorithm;
(d) computing food ranking; and
(e) providing a diet recommendation;
providing a food matching stage, the food matching stage comprising:
(f) selecting a food item to be replaced;
(g) determining a threshold of target similarity; and
(h) providing at least one replaceable food item.

2. The method of claim 1, wherein the personal nutrient goal comprises a target nutrient feature based on personal health conditions.

3. The method of claim 1, wherein the method further comprises inputting a personal preference.

4. The method of claim 3, wherein the personal preference comprises a preferred food category.

5. The method of claim 1, wherein step (b) setting a weight and a necessity value for each target nutrient feature is done by a user, wherein the user is an average person or an expert from the health care industry.

6. The method of claim 1, wherein the clustering algorithm is a Hierarchical Agglomerative Algorithm.

7. The method of claim 6, wherein the Hierarchical Agglomerative Algorithm uses an Average-Linkage Agglomerative Algorithm to compute the similarities of the food clusters.

8. The method of claim 1, wherein step (c) further comprises defining a threshold of similarity among the food items in the food clusters to control the convergence level of each of the food clusters.

9. The method of claim 1, wherein step (c) further comprises defining the number of food items in the food clusters to control the size of each of the food clusters.

10. The method of claim 1, wherein step (d) comprises:
calculating a ranking value for each food item f with the equation: ranking(f)=ΣWiNi, wherein Wi is the weight of target nutrient feature i of food item f, Ni is the value of target nutrient feature i of food item f, Ni is positive when the necessity value of target nutrient feature i of food item f is set to high, and Ni is negative when the necessity value of target nutrient feature i of food item f is set to low; and
ranking the food items based on the ranking value.

11. The method of claim 1, wherein step (e) further comprises providing the function of browsing the diet recommendation by category.

12. The method of claim 1, wherein at step (g) when the threshold of target similarity is determined as equal to the similarity of the food cluster to which the food item to be replaced belongs, providing the food ranking result of the food cluster to which the food item to be replaced belongs at step (h).

13. The method of claim 1, wherein at step (g) when the threshold of target similarity is determined as not equal to the similarity of the food cluster to which the food item to be replaced belongs, generating the corresponding food clusters, computing food ranking, and providing at least one replaceable food item at step (h).

14. A system of personalized meal planning, utilizing a food clustering technique to generate personalized meal plans, comprising:
a food database which provides a plurality of food items and a plurality of nutrient features of the food items;
a data collecting module for collecting a personal nutrient goal from a user;
a nutrient feature weighting module for allowing the user to set a weight and a necessity value for each target nutrient feature;
a food clustering module for generating a plurality of food clusters by applying a clustering algorithm;
a food ranking module for computing food ranking among the food items in the food clusters;
a food cluster database which stores the data related to the food clusters;
a diet recommendation module for providing a diet recommendation; and
a food matching module for providing replaceable food matching based upon a threshold of target similarity.

15. The system of claim 14, wherein the personal nutrient goal comprises a target nutrient feature based on personal health conditions.

16. The system of claim 14, wherein the data collecting module further comprises collecting a personal preference from a user.

17. The system of claim 16, wherein the personal preference comprises a preferred food category.

18. The system of claim 14, wherein the clustering algorithm is a Hierarchical Agglomerative Algorithm.

19. The system of claim 18, wherein the Hierarchical Agglomerative Algorithm uses an Average-Linkage Agglomerative Algorithm to compute the similarities of the food clusters.

20. The system of claim 14, wherein the food clustering module further comprises defining a threshold of similarity among the food items in the food clusters to control the convergence level of each of the food clusters.

21. The system of claim 14, wherein the food clustering module further comprise defining the number of food items in the food clusters to control the size of each of the food clusters.

22. The system of claim 14, wherein the food ranking module calculates a ranking value for each food item f with the equation: ranking(f)=ΣWiNi, and ranks the food items based on the ranking value, wherein Wi is the weight of target nutrient feature i of food item f, Ni is the value of target nutrient feature i of food item f, Ni is positive when the necessity value of target nutrient feature i of food item f is set to high, and Ni is negative when the necessity value of target nutrient feature i of food item f is set to low.

23. The system of claim 14, wherein the diet recommendation module further provides the function of browsing the diet recommendation by category.

24. The system of claim 14, wherein when the food matching module determines the threshold of target similarity as equal to the similarity of the food cluster to which the food item to be replaced belongs, the food ranking module provides the food ranking result of the food cluster to which the food item to be replaced belongs.

25. The system of claim 14, wherein when the food matching module determines the threshold of target similarity as not equal to the similarity of the food cluster to which the food item to be replaced belongs, the food clustering module generates the corresponding food clusters, the food ranking module computes food ranking, and the food matching module provides at least one replaceable food item.

26. A computer usable medium having stored thereon a computer readable program for causing a computer to execute personalized meal planning, the program comprising:
providing a food clustering stage, the food clustering stage comprising:
(a) inputting a personal nutrient goal;
(b) setting a weight and a necessity value for each target nutrient feature;
(c) generating a plurality of food clusters by applying a clustering algorithm;
(d) computing food ranking; and
(e) providing a diet recommendation;
providing a food matching stage, the food matching stage comprising:
(f) selecting a food item to be replaced;
(g) determining a threshold of target similarity; and
(h) providing at least one replaceable food item.

27. The medium of claim 26, wherein the personal nutrient goal comprises a target nutrient feature based on personal health conditions.

28. The medium of claim 26, wherein the method further comprises inputting a personal preference.

29. The medium of claim 28, wherein the personal preference comprises a preferred food category.

30. The medium of claim 26, wherein step (b) setting a weight and a necessity value for each target nutrient feature is done by a user, wherein the user is an average person or an expert from health care industry.

31. The medium of claim 26, wherein the clustering algorithm is a Hierarchical Agglomerative Algorithm.

32. The medium of claim 31, wherein the Hierarchical Agglomerative Algorithm uses an Average-Linkage Agglomerative Algorithm to compute the similarities of the food clusters.

33. The medium of claim 26, wherein step (c) further comprises defining a threshold of similarity among the food items in the food clusters to control the convergence level of each of the food clusters.

34. The medium of claim 26, wherein step (c) further comprises defining the number of food items in the food clusters to control the size of each of the food clusters.

35. The medium of claim 26, wherein step (d) comprises:
calculating a ranking value for each food item f with the equation: ranking(f)=ΣWiNi, wherein Wi is the weight of target nutrient feature i of food item f, Ni is the value of target nutrient feature i of food item f, Ni is positive when the necessity value of target nutrient feature i of food item f is set to high, and Ni is negative when the necessity value of target nutrient feature i of food item f is set to low; and
ranking the food items based on the ranking value.

36. The medium of claim 26, wherein step (e) further comprises providing the function of browsing the diet recommendation by category.

37. The medium of claim 26, wherein at step (g) when the threshold of target similarity is determined as equal to the similarity of the food cluster to which the food item to be replaced belongs, providing the food ranking result of the food cluster to which the food item to be replaced belongs at step (h).

38. The medium of claim 26, wherein at step (g) when the threshold of target similarity is determined as not equal to the similarity of the food cluster to which the food item to be replaced belongs, generating the corresponding food clusters, computing food ranking, and providing at least one replaceable food item at step (h).
